(19) United States
(12) Patent Application Publication
(10) Pub. No.: US 2020/0039862 A1
(43) Pub. Date: Feb. 6, 2020

(54) MOLD FOR PROCESSING GLASS

(71) Applicant: AAC Technologies Pte. Ltd., Singapore city (SG)

(72) Inventors: Yuqin Yuan, Shenzhen (CN); Xiaogang Zhai, Shenzhen (CN); Wei Su, Shenzhen (CN)

(21) Appl. No.: 16/527,027

(22) Filed: Jul. 31, 2019

(30) Foreign Application Priority Data
Aug. 2, 2018 (CN) 201821242407.5

(51) Int. Cl. C03B 23/03

(52) U.S. Cl. CPC C03B 23/0302; C03B 2215/05

(57) ABSTRACT

Disclosed is a mold for processing glass. The mold includes a concave mold having a cavity and a convex mold mating with the concave mold. When the molds are clamped, the convex mold protrudes into the cavity. The mold further includes a base, wherein the base is detachably fixed on a side of the convex mold distal from the cavity, and a material of the base is different from that of the concave or the convex mold fixed thereto. The mold according to the present disclosure may improve manufacture efficiency of three-dimensional glass substrates and has a prolonged life time.

### FIELD OF THE DISCLOSURE

The present disclosure relates to the technical field product processing and product molding, and in particular, relates to a mold for processing glass.

### DESCRIPTION OF RELATED ART

With the development of the Internet era, electronic devices are more and more widely being used, such as mobile phones, tablets, and notebooks. In addition to functionality requirements, users are also imposing higher and higher requirements on appearance design of the electronic devices. Housings of the electronic devices are increasingly employing three-dimensional glass products.

In the related art, three-dimensional glass products are generally manufactured using a glass processing mold by a hot rolling forming process. This glass processing mold generally includes a concave mold having a cavity and a convex mold mating with the concave mold. After the convex mold and the concave mold are clamped, a gap having a predetermined shape may be defined by enclosing the convex mold and the concave mold. In this way, shapes of glass substrates in a thermally melted sate are constrained by using this gap to mold the glass substrates. Afterwards, the glass substrates is cooled to yield three-dimensional glass products having a predetermined shape.

During practice of the present disclosure, the inventors have found that the related art has at least the following problems: The processing method of the glass substrate specifically includes the following steps:

In order to meet a matching strength between molded glass and the convex and concave molds, materials of the concave and convex molds are generally graphite. Since the graphite has a poor wear resistance, if a hot rolling mold has a complicated structure, especially, if the other parts of the mold need to move on the graphite material, the surface of the graphite may be easily deformed due to wear, thereby shortening life time of the glass mold.

Therefore, it is desired to provide an innovative mold for processing three-dimensional glass substrates to overcome the above problems.

### BRIEF DESCRIPTION OF THE DRAWINGS

Various aspects of some exemplary embodiments may be better understood with reference to the accompanying drawings. The components in the drawings are not necessarily drawn to scale, and the emphasis is instead placed upon clearly illustrating the principles of the present disclosure. Moreover, in the drawings, like reference numerals designate corresponding parts throughout the several views.

FIG. 1 is a perspective view of a mold for processing glass according to a first embodiment of the present disclosure;

FIG. 2 is a perspective view of a mold for processing glass according to a second embodiment of the present disclosure; and

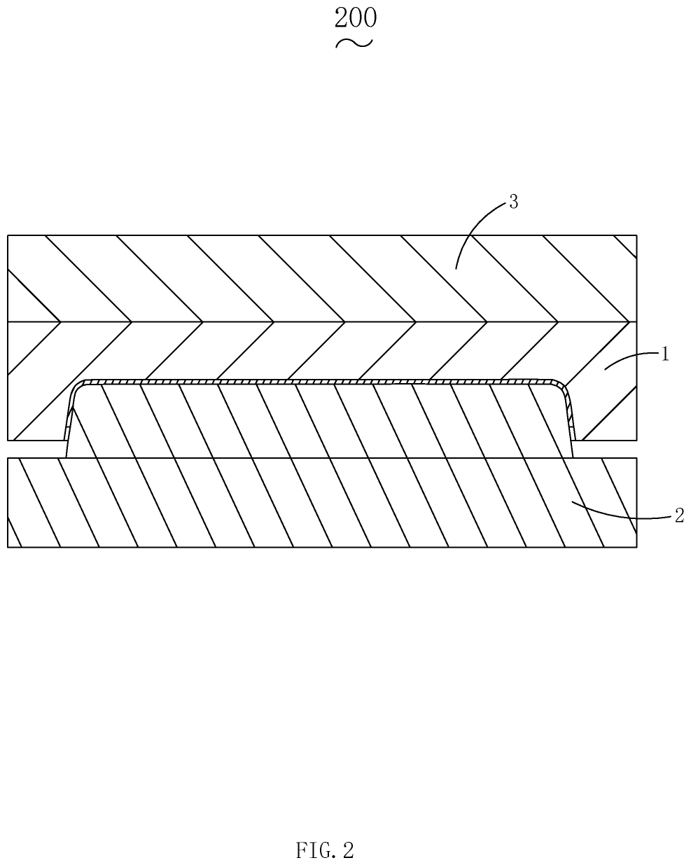

FIG. 3 is a perspective view of a mold for processing glass substrate according to a third embodiment of the present disclosure.

### DETAILED DESCRIPTION

For clearer descriptions of the objectives, technical solutions, and advantages of the present invention, the present disclosure is described in detail with reference to accompanying drawings and specific embodiments. However, persons of ordinary skill in the art may understand, in the embodiments of the present disclosure, more technical details are provided for readers to better understand the present disclosure. However, even though these technical details and various variations and modifications based on the embodiments hereinafter, the technical solutions of the present disclosure may also be practiced.

A first embodiment of the present disclosure relates to a mold 100 for processing glass.

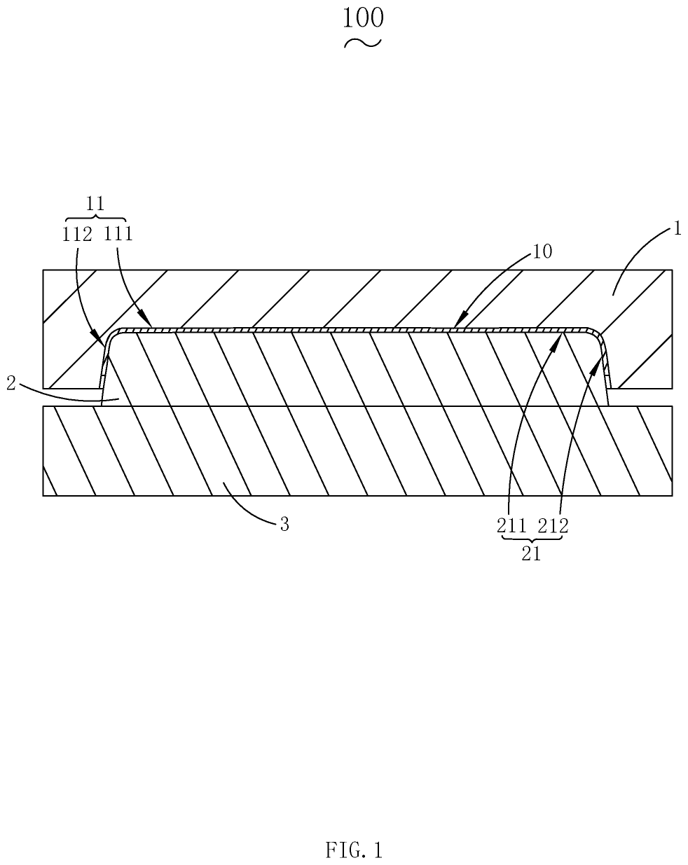

As illustrated in FIG. 1, the mold 100 includes a concave mold 1 having a cavity 10 and a convex mold 2 mating with the concave mold 1. When the concave mold 1 and the convex mold 2 are clamped, the convex mold 2 protrudes into the cavity 10. The mold 100 further includes a base 3. The base 3 is detachably fixed on a side of the convex mold 2 distal from the cavity 10, and a material of the base 3 is different from that of the convex mold 2.

Relative to the related art, in the embodiment of the present disclosure, by fixing the base 3, which is made of a material different from that of the convex mold 2, on the side of the convex mold 2 distal from the cavity 10, in one aspect, the materials of the concave mold 1 and the convex mold 2 are selected only in consideration of a molding effect of three-dimensional glass products, but without considering mating with the other parts of the mold 100 and movement precision; and in another aspect, the material of the base 3 is selected with no need to consider the molding of the three-dimensional glass products, and instead, the movement precision of the base 3 and the mating with the other parts of the mold only need to be ensured. In this way, materials achieving a good molding effect, good thermal conductivity or accommodating requirements of molding glass having particular shapes may be selected, such that time for heating and cooling the concave mold and the convex mold is reduced and the particular requirements are accommodated, and thus manufacture efficiency of the three-dimensional glass products is improved. Specifically, materials having a high strength and good wear resistance are selected to manufacture the base 3, such that life time of the mold 100 is prolonged.

It is worth mentioning that because the convex mold 2 is detachably fixed on the base 3, the convex mold may be conveniently replaced whenever the convex mold 2 is damaged.

It is to be understood that the materials of the convex mold 2 and the concave mold 1 are preferably at least one of graphite or ceramic. The thermal conductivity of the graphite exceeds that of steel, iron, lead and other metal materials. The thermal conductivity decreases with the increase of temperature. At extremely high temperatures, the graphite becomes a thermal insulator. Therefore, the concave and convex molds made of the graphite or the ceramic may be heated or cooled in a shorter time. The material of the base 3 is preferably at least one of a nickel-based alloy or a tungsten steel. The nickel-based alloy has excellent high temperature resistance and corrosion resistance, and the tungsten steel (a hard alloy) has a series of excellent properties, such as high hardness, wear resistance, excellent strength and toughness, heat resistance and corrosion resistance, and on the like. Therefore, the use of the base made of the nickel-based alloy or the tungsten steel may prolong the life time of the mold 100. In addition, the materials of the convex mold 2 and the concave mold 1 have corresponding merits if the hard alloy or the nickel-based alloy is used.

Implementation details of the mold 100 according to the present disclosure will be specifically described hereinafter. The following details are merely for facilitating understanding of the implementation details, and are not necessary for practicing the solution.

Specifically, the concave mold 1 includes an inner wall 11 enclosing the molding cavity 10, and the convex mold 2 includes an outer surface 21 facing towards the inner wall 11, and the outer surface 21 and the inner wall 11 define a molding space for molding a three-dimensional glass structure.

It should be noted that the inner wall 11 includes a bottom wall 111 at a bottom of the cavity 10, and a side wall 112 bending and extending from the bottom wall 111. The outer surface 21 includes a top surface 211 facing towards the bottom wall 111, and a side surface 212 extending from the top surface 211 towards a direction away from the bottom wall 111. The bottom wall 111, the side wall 112, the top surface 211 and the side surface 212 collaboratively define a molding space. The molding space may facilitate constrainment on the shapes of the glass substrates in a thermally melted state, and the glass substrate may be cooled to form three-dimensional glass products having a predetermined shape.

Preferably, a chamfer is arranged at both a connection point of the bottom wall 111 and the side wall 112, and a connection point of the top surface 211 and the side surface 212. The shape of the chamfer may be determined according to desired shapes of finished three-dimensional glass products.

A second embodiment of the presented disclosure relates to a mold 200 for processing glass. The second embodiment is approximately the same as the first embodiment. The difference lies in that in the first embodiment, the base 3 is detachably fixed on the side of the convex mold 2 distal from the cavity 10, and the materials of the base 3 and the convex mold 2 are different. However, in the second embodiment, the base 3 is detachably fixed on a side of the concave mold 1 distal from the cavity 10, and the materials of the base 3 and the concave mold 1 are different. In addition, a person skilled in the art may understand that the second embodiment may achieve the same beneficial effect as the first embodiment.

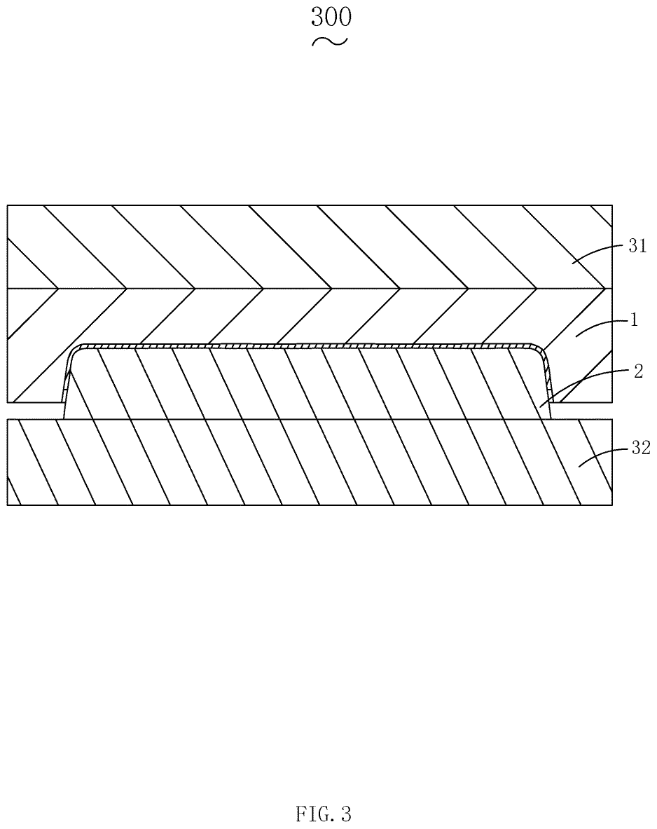

A third embodiment of the present disclosure relates to a mold 300 for processing glass. The third embodiment is approximately the same as the first embodiment. The difference lies in that in the first embodiment, the base 3 is detachably fixed on the side of the convex mold 2 distal from the cavity 10, and the materials of the base 3 and the convex mold 2 are different. However, in the third embodiment, as illustrated in FIG. 3, the base 3 includes a first base 31 and a second base 32, wherein the first base 31 is detachably fixed on the side of the concave mold 1 distal from the cavity 10, and the second base 32 is detachably fixed on the side of the convex mold 2 distal from the cavity 10; materials of the first base 31 and the concave mold 1 are different; and materials of the second base 32 and the convex mold 2 are also different.

Persons of ordinary skill in the art shall understand that the above embodiments are merely specific and exemplary embodiments for practicing the present disclosure, and in practice, various modifications may be made to these embodiments in terms of form and detail, without departing from the spirit and scope of the present disclosure.

What is claimed is:

1. A mold for processing glass, comprising:
a concave mold having a cavity;
a convex mold mating with the concave mold, the convex mold protruding into the cavity of the concave mold when the concave mold and the convex mold are clamped;
wherein the mold for processing the glass further comprises a base, the base being detachably fixed on a side of the concave mold or the convex mold distal from the cavity, and a material of the base is different from that of the concave or convex mold fixed thereto.

2. The mold for processing glass according to claim 1, wherein the concave mold comprises an inner wall enclosing the cavity, and the convex mold comprises an outer surface facing towards the inner wall, the outer surface and the inner wall being jointly enclosed to define a molding space for molding a three-dimensional glass structure.

3. The mold for processing glass according to claim 2, wherein the inner wall comprises a bottom wall positioned at a bottom of the cavity and a side wall bending and extending from the bottom wall, and the outer surface comprises a top surface facing towards the bottom wall and a side surface extending from the top surface towards a direction away from the bottom wall, the bottom wall, the side wall, the top surface and the side surface being cooperatively enclosed to define the molding space.

4. The mold for processing glass according to claim 3, wherein a chamfer is arranged at both a connection point of the bottom wall and the side wall and a connection point of the top surface and the side surface.

5. The mold for processing according to claim 1, wherein the materials of the concave mold and the convex mold comprise at least one of graphite, ceramic, nickel-based alloy or cemented carbide.

6. The mold for processing glass according to claim 1, wherein the material of the base comprises at least one of graphite, ceramic, nickel-based alloy or tungsten steel.
